(19) United States
(12) Patent Application Publication
(10) Pub. No.: US 2016/0077626 A1
(43) Pub. Date: Mar. 17, 2016

(54) LAYER STRUCTURE FOR TOUCH PANEL AND TOUCH PANEL USING SAME

(71) Applicant: APEX MATERIAL TECHNOLOGY CORP., Keelung City (TW)

(72) Inventors: JERRY YEH, Keelung City (TW); PING JUNG KAO, Keelung City (TW)

(21) Appl. No.: 14/485,067

(22) Filed: Sep. 12, 2014

(51) Int. Cl. G06F 3/044

(52) U.S. Cl. CPC G06F 3/044

(57) ABSTRACT

Layer structure for a touch panel, and a touch panel using the same are provided. In an embodiment, the layer structure includes a substrate; a transparent conductive layer, and an opaque area. The transparent conductive layer, disposed on the substrate, includes at least one electrode. The opaque area, disposed on a peripheral area of the transparent conductive layer, includes a conductive film layer. In addition, the opaque area can further include a dielectric film layer.

### FIELD

The present invention relates to a touch panel. In particular, it relates to a layer structure for a touch panel, and a touch panel using the same.

### BACKGROUND

Since the touch panel is artfully managed to combine the interfaces of input and output, it has strong advantages regarding space saving and user-friendly operation during implementation. Thus currently the touch panel has been widely applied to various consumer-end products or industrial electronic devices, such as personal digital assistants (PDA), palm-sized PCs, tablet computers, handwriting input devices, smart phones, information appliances, automated teller machines (ATM), and Point-Of-Sale (POS) terminals, and is widely seen in diversely commercial and industrial applications.

Touch panels are classified into five categories, such as a resistive touch panel, a projective-capacitive touch panel, an optical touch panel, an electromagnetic touch panel and an acoustic wave touch panel according to the sensing principle. Each type of the touch panels has its advantages and disadvantages in size, cost, manufacture, and accuracy of operation. For example, the rate of transmission and response time of the projective-capacitive touch panel is higher than that of the resistive touch panel. The projective-capacitive touch panel also demonstrates superb performance in certain features such as anti-fire, anti-fouling, anti-scratching, anti-statics, and anti-dirt.

Of the types of touch panels presently available, resistive and projective-capacitive touch panels are the most popular owing to the low price, wherein the resistive touch panel is classified as 4-wire, 5-wire, 6-wire, 7-wire, and 8-wire according to the wiring arrangement of electrodes. In Taiwan patent application No. 096115419 filed by the Applicant, the structure and operation of 4-wire and 5-wire touch panels are explicitly described. In Taiwan patent application No. 094102548 filed by the Applicant, the structure and operation of the 5-wire touch panel are explicitly described. In Taiwan patent application No. 100205766 filed by the Applicant, the structure and operation of the projective-capacitive touch panel are explicitly described.

The aspects of design and development of any kinds of touch panels are tendencies of beautification, thinning down, and cost reduction. But the original controlling functionalities such as sensitivity, durability, and definition cannot be sacrificed while attempting to improve the aforementioned factors. Under such considerations, the design and development of the top layer of the touch panel, i.e. the side facing the user, become an important issue.

Please refer to FIGS. 1(a) to 1(b) illustrating a schematic diagram of a side view of the layer structure of the known resistive touch panel. FIG. 1(b) is a schematic diagram illustrating a top view from the front of the known resistive touch panel corresponding to FIG. 1(a). The touch panel 10 shown in FIG. 1(a) is constructed by a bottom layer 11, a top layer 12, a frame gel 13 and a spacer 14, wherein the bottom layer 11, generally, is a substrate 11b with a transparent conductive material 11a disposed on the surface thereof. The substrate 11b is PC or glass and the top layer 12 is a polyethylene terephthalate substrate 12b with a transparent conductive material 12a disposed on the surface thereof.

There is a spacer 14 disposed between the top layer 12 and bottom layer 11 for separating those two and avoiding coupling between the bottom layer 11 and the top layer 12. The bottom layer 11 is assembled with the top layer by the frame gel 13. A transparent protecting layer 18 is stuck on the top of the entire touch panel 10 by a gel 16, and a surface S of the touch panel 10 is rendered thereby to show a flat appearance ultimately.

Please refer to FIG. 1(b). The surface of the resistive touch panel is typically divided into two areas: an active area and a frame area when it is viewed from the front appearance. The active area, or AA, is used to receive the user's touch for input, and the frame area, or FA, is used for the trace and circuit inside the touch panel. An opaque sheltering layer 17 is disposed between the transparent protecting layer 18 and the top layer 12 of the touch panel 10 corresponding to frame area FA by the gel 16. The opaque sheltering layer 17 is generally black and it can just cover the frame area FA to shelter the disordered trace and circuit under the frame area FA for showing a flat, slim, beautiful, clear, and succinct appearance surface S of the touch panel in front of the user.

The user render the bottom layer 11 and the top layer 12 to be contacted and coupled by pressing the active area AA on the surface S. The touch panel 10 can detect the pressed location and generate controlling signals. An output circuit 15 is connected to the lateral side of the top layer 12 and the bottom layer 11 for generating controlling signals.

Please refer to FIG. 2(b) illustrating a schematic diagram of a top view of the back side of the top structure of the known projective-capacitive touch panel. The touch panel 20 of the top structure in FIG. 2(a) comprises a substrate 21, a sensing electrode 22, a Y-axis electrode layer 23, an X-axis electrode layer 24, a Y-axis flat cable of circuit 25 and a X-axis flat cable of circuit 26, wherein the sensing electrodes 22 are disposed on the active area AA of the touch panel 20 for sensing the input signal generated by user's touch. The Y-axis electrode layer 23 connects to the Y-axis flat cable of circuit 25. The X-axis electrode layer 24 connects to the X-axis flat cable of circuit 26. The Y-axis flat cable of circuit 25 and the X-axis flat cable of circuit 26 sense all the input signals generated by the sensing electrodes 22 along the trace of the frame area FA of the touch panel 20 and send the input signals to external processor.

Please refer to FIGS. 2(a) and 2(b), wherein FIG. 2(b) is the appearance of the front of the top structure of the touch panel 20. FIG. 2(a) shows a top view of the back of the top structure of the touch panel 20, i.e. the side that does not face the user directly. But an opaque sheltering layer 27 is required to be disposed on the front of the opposite side for, i.e. the side that faces the user directly, like the aforementioned resistive touch panel for showing a flat, slim, beautiful, clear, and succinct appearance surface S of the touch panel in front of the user as shown in FIG. 2(b).

The aforementioned opaque sheltering layer disposed therein will increase the thickness of the resistive or capacitive touch panels. Meanwhile, the surface cannot present a flat surface owing to the difference of the thickness between the opaque sheltering layer and the protecting layer. Furthermore, an addition of a material of the sheltering layer will increase the entire cost of the touch panel.

### SUMMARY

The invention is directed to provide a layer structure for a touch panel, and a touch panel using the same.

According to one aspect of the invention, an embodiment of a layer structure is provided. The layer structure includes a substrate; a transparent conductive layer, disposed on the substrate, comprising at least one electrode; and an opaque area, disposed on a peripheral area of the transparent conductive layer, including a conductive film layer. In addition, the opaque area can further include a dielectric film layer.

According to another aspect of the invention, an embodiment of a touch panel is provided. The touch panel includes an upper structure and a lower structure. The upper structure provides an active area and a frame area, and includes: a first substrate, a first transparent conductive layer, and an opaque area. The first transparent conductive layer, disposed on the first substrate, includes at least one electrode. The opaque area, disposed on a peripheral area of the first transparent conductive layer, includes a conductive film layer. The lower structure includes a second substrate; and a second transparent conductive layer disposed on the second substrate.

### DESCRIPTION OF THE DRAWINGS

A more complete appreciation of the invention and many of the attendant advantages thereof are readily obtained as the same become better understood by reference to the following detailed description when considered in connection with the accompanying drawing.

FIG. 1(a) is a schematic diagram illustrating a side view of the layer structure of the known resistive touch panel.

FIG. 1(b) is a schematic diagram illustrating a top view from the front of the known resistive touch panel corresponding to FIG. 1(a).

FIG. 2(a) is a schematic diagram illustrating a top of the back side of the top structure of the known projective-capacitive touch panel.

FIG. 2(b) is a schematic diagram illustrating an appearance of the front side of the top structure of the known projective-capacitive touch panel.

FIG. 3 is a flow chart illustrating the method for manufacturing the substrate structure for the touch panel of the present invention.

FIGS. 4(a) to 4(c) are schematic diagrams illustrating the first embodiment in accordance with the present invention.

FIGS. 5(a) to 5(d) are schematic diagrams illustrating the second embodiment in accordance with the present invention.

FIGS. 6(a) to 6(f) are schematic diagrams illustrating the third embodiment in accordance with the present invention.

FIGS. 7(a) to 7(d) are schematic diagrams illustrating the forth embodiment in accordance with the present invention.

FIGS. 8(a) to 8(c) are schematic diagrams illustrating the fifth embodiment in accordance with the present invention.

FIGS. 9(a) to 9(c) are schematic diagrams illustrating the sixth embodiment in accordance with the present invention.

FIGS. 10(a) to 10(d) are schematic diagrams illustrating the seventh embodiment in accordance with the present invention.

FIGS. 11(a) to 11(d) are schematic diagrams illustrating the eighth embodiment in accordance with the present invention.

FIGS. 12(a) to 12(d) are the ninth embodiment in accordance with the present invention.

FIG. 13(a) is a schematic diagram illustrating the final appearance in accordance with the present invention.

FIGS. 13(b) to 13(d) are cross-sectional views illustrating some embodiments of a top layer of a touch panel.

FIG. 14(a) is a schematic diagram illustrating a top of the front side of the top structure of a touch panel according to an embodiment.

FIG. 14(b) is a schematic diagram illustrating an appearance of the back side of the top structure of the touch panel in FIG. 14(a).

FIG. 14(c) is a schematic diagram illustrating a side view of the layer structure of the touch panel.

FIG. 14(d) is a schematic diagram illustrating a top of the front side of the top structure of the touch panel after thermal curing.

FIG. 14(e) is the tenth embodiment in accordance with the present invention.

FIGS. 15(a) to 15(b) are the eleventh embodiment in accordance with the present invention.

FIG. 16 is a schematic diagram illustrating the final appearance for the eleventh embodiment in accordance with the present invention.

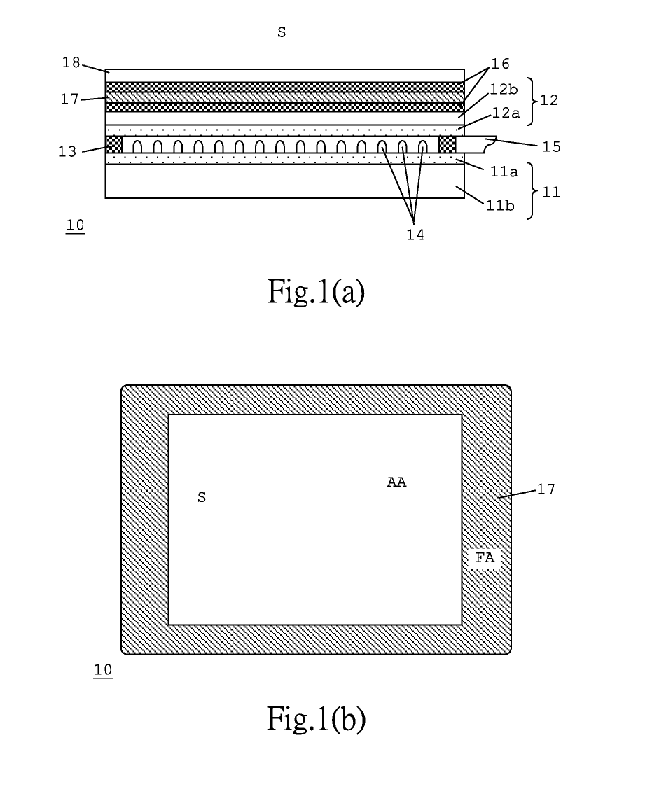

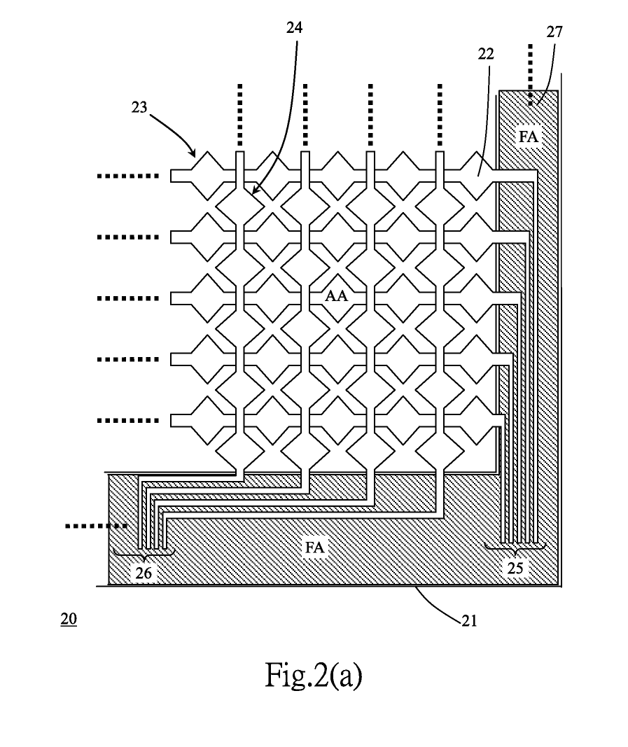

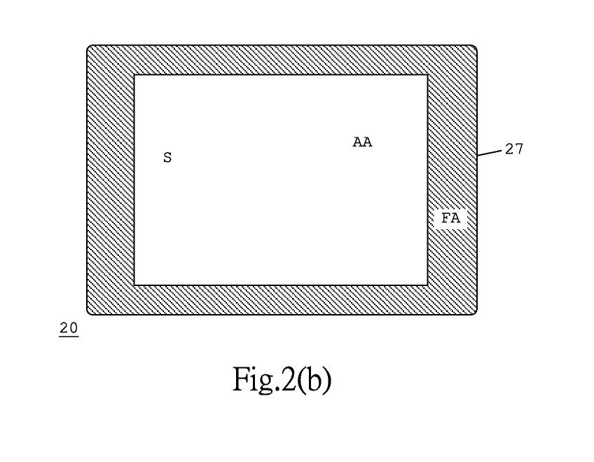

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “including”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The conductive substrate according to the present invention can be constructed by a substrate layer and a conductive film layer. The material of such substrate layer is preferably, but not limited to, an insulated material including one of a polycarbonate (PC) material, a polyethylene (PE) material, a polyethylene terephthalate (PET) material, a polyethylene naphthalate (PEN) material, a polymethylmethacrylate (PMMA) material, a triacetyl cellulose (TAC) material, and a glass and the like. A conductive film layer is formed on the substrate layer and such conductive film layer is preferably, but not limited to, one of an indium tin oxide (ITO) material, a fluorine tin oxide (FTO) material, an antimony tin oxide material, and a carbonate material.

The material of the dielectric substrate is preferably, but not limited to, an insulated material including one of a polycarbonate (PC) material, a polyethylene (PE) material, a polyethylene terephthalate (PET) material, a polyethylene naphthalate (PEN) material, a polymethylmethacrylate (PMMA) material, a triacetyl cellulose (TAC) material, and a glass and the like.

The conductive substrate and the dielectric substrate are used as a top structure, or an upper structure, of the touch panel. Take a resistive touch panel for an example; the top structure and the bottom structure (or a lower structure) are assembled to form a main structure as a sandwiched-laminated structure. Take a capacitive touch panel for an example, its top structure forms a layer with sensing electrodes.

Regarding the conductive substrate, the front side indicates a side without a conductive film layer which is also a front in the top structure facing the user ultimately and the back side indicates a side with a conductive film layer. Take the resistive touch panel for example; a back side is used for assembling with the bottom structure in the top structure. Take the capacitive touch panel for example, a back side is used for forming a layer with sensing electrodes in the top structure

Regarding the dielectric substrate, the front side indicates a side without a conductive film layer formed whereon which is also a front in the top structure facing the user ultimately, and the back side indicates a side with a conductive film layer formed in the process. Take the resistive touch panel for example; a back side is used for assembling with the bottom structure in the top structure. Take the capacitive touch panel for an example; the back side is used for forming a layer with sensing electrodes in the top structure

For the sake of convenience, the ITO substrate represents the conductive substrate in the embodiments, but the implementation of the conductive substrate of the embodiments of present invention is not limited to the ITO substrate.

The embodiments of present invention are applicable to any kinds of resistive touch panels, capacitive touch panels, and electromagnetic touch panels. For the sake of convenience, the resistive touch panel and the projective-capacitive touch panel are illustrated in the embodiments, but the implementation of the embodiments is not limited to the resistive touch panel and the projective-capacitive touch panel.

In the following embodiment, one or more layer that are opaque with color(s) in a frame area, such as a dielectric film layer or a conductive film layer or any combination or arrangement of the dielectric film layer and the conductive film layer, can be regarded as an opaque area. The opaque area may include a conductive film layer, or a dielectric film layer, or any combination or arrangement thereof. For example, the dielectric ink and the conductive ink are opaque inks and can be used to implement the dielectric film layer or a conductive film layer, the colors of which can be, but not limited to, one of black, silver, white, blue, yellow and the like. In addition, the opaque area is, for example, disposed on a peripheral area of a transparent conductive layer or ITO conductive film layer of the layer structure, wherein one or more electrodes can be formed based on the transparent conductive layer or ITO conductive film layer of the layer structure.

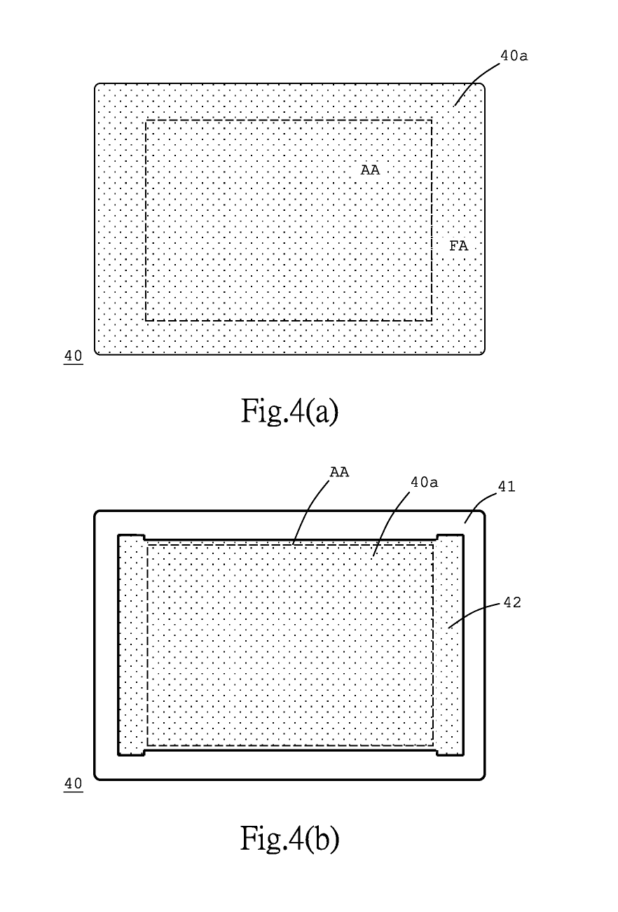

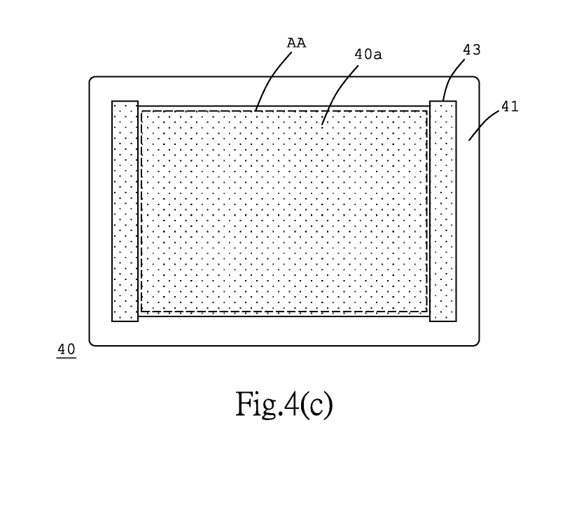

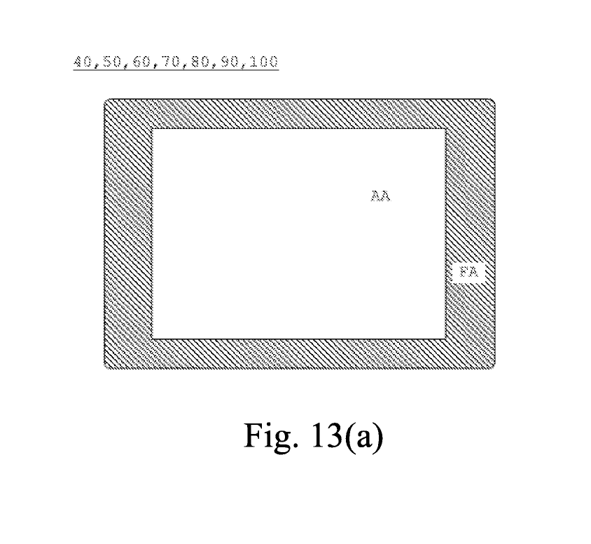

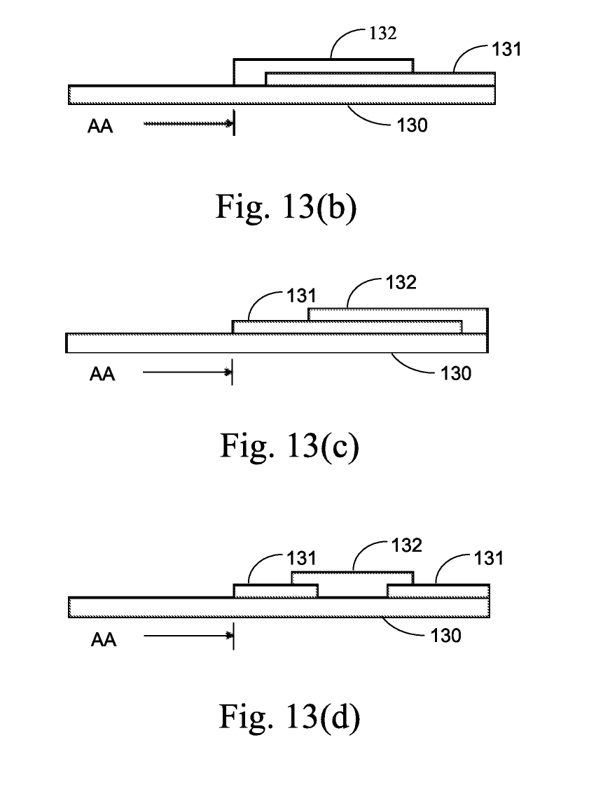

The back side is shown in FIG. 4(a) to FIG. 12(d) in accordance with the present invention, i.e. the side used for assembling with the bottom structure on the top structure. The front side is shown in FIG. 13(a), i.e. the side facing the user ultimately.

The disclosure will now be described by a detailed description of several embodiments. It is clear that other embodiments can be configured according to the knowledge of persons skilled in the art without departing from the true technical teaching of the present disclosure.

Please refer to FIGS. 4(a) to 4(c), which illustrates the first embodiment in accordance with the present invention. The ITO substrate 40 shown in FIG. 4(a) to FIG. 4(c) is preferably used as a top structure of a 4-wire or 8-wire resistive touch panel. The back side of the ITO substrate 40 is shown in FIG. 4(a) to FIG. 4(c).

The ITO substrates 40 shown in FIG. 4(a) to FIG. 4(c) are planned in advance for a frame area FA near edges that occupies less area of the ITO substrates, and a large active area AA at the center according to the use.

In FIG. 4(a), an ITO substrate 40 is first provided. FIG. 4(a) is a vertical view of the back side of the ITO substrates 40. The ITO substrates 40 in the FIG. 4(a) is formed with a substrate layer and an ITO conductive film layer 40a. Since the substrate layer is under the ITO conductive film layer 40a, the substrate layer is not shown in FIG. 4(a).

In FIG. 4(b), subsequently a dielectric film layer 41 is formed on top of the ITO conductive film layer 40a of the ITO substrate 40 and the frame area FA near edges of the ITO substrate 40 by a process including one of the screen printing process, the transfer printing process, the inkjet printing process, and the plating process. When the dielectric film layer 41 was printed on top of the ITO conductive film layer 40a, the remaining portion of the ITO conductive film layer 40a uncovered by the dielectric film layer 41 comprises the active area AA and a conductive area 42. The pattern of the dielectric film layer 41 is managed to expose the conductive area 42 when designing the dielectric film layer 41.

In FIG. 4(c), a conductive film layer 43 is formed in a range larger than the conductive area 42 by a process including one of the screen printing process, the transfer printing process, the inkjet printing process and the plating process. The conductive film layer 43 is rendered to cover and have contact with the ITO conductive film layer 40a on top of the active area AA and the ITO conductive film layer 40a on the active area AA is rendered to be electrically coupled to the conductive film layer 43. It is to be noticed that the dielectric film layer 41 and the conductive film layer 43 are preferably opaque and have thin film materials with the same color which are opaque inks having the same color code, i.e. the dielectric film layer 41 and the conductive film layer 43 are preferably opaque inks having the same color in, such as black, silver, white, red, blue or yellow. When the conductive film layer 43 was printed on top of the ITO conductive film layer 40a, the active area AA and the frame area FA are explicitly defined on the ITO substrate 40.

When both of the dielectric film layer 41 and the conductive film layer 43 were printed, the trace or the circuit required for the 4-wire or 8-wire resistive touch panel can be disposed on the frame area FA which comprises the dielectric film layer 41 and the conductive film layer 43. Since the ITO substrate 40 is used as a top structure of the touch panel, its front side is the surface facing the user and the final appearance is shown as FIG. 13(a). Under the shelter of the dielectric film layer 41 and the conductive film layer 43, the active area AA and the frame area FA are orderly delimited. The active area AA is also a screen displaying area. When the ITO substrate 40 was assembled on the touch panel, the trace or the circuit required for the 4-wire or 8-wire resistive touch panel configured on the dielectric film layer 41 and the conductive film layer 43 can be sheltered by the colored dielectric film layer 41 and the conductive film layer 43, and they will not be seen on the appearance so that the appearance of the device seen by the user from the front of the touch panel is a complete, clear, and full-flat surface for use as show in FIG. 13(a). There are advantages such as simplicity and reduced costs of the whole process.

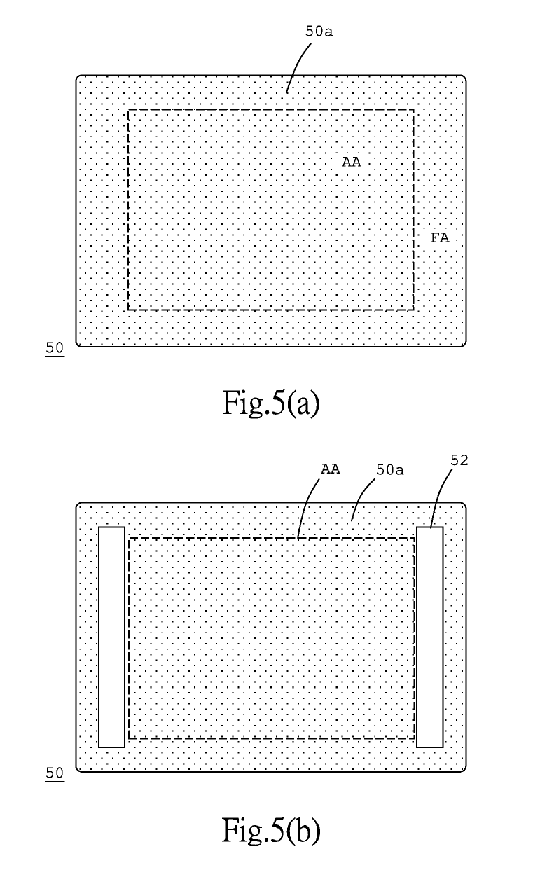

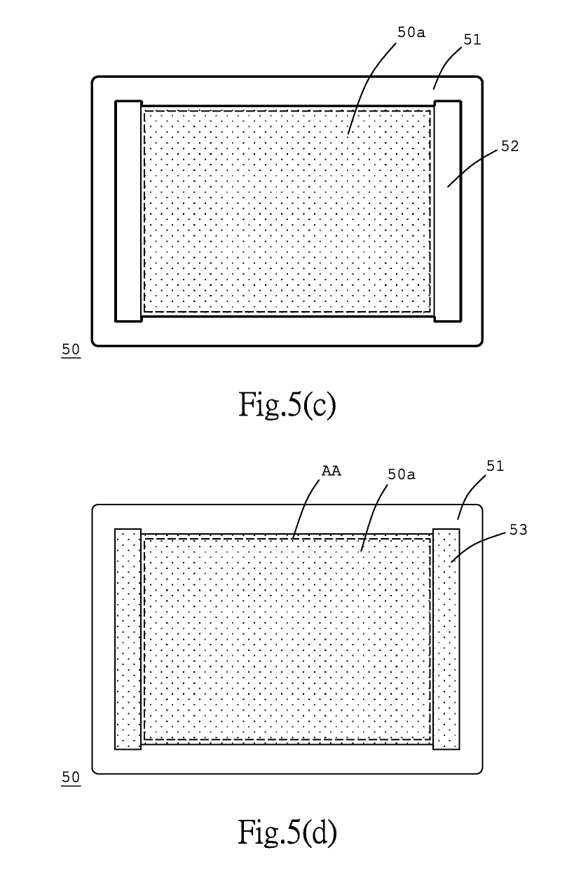

Please refer to FIGS. 5(a) to 5(d), which illustrate the second embodiment in accordance with the present invention. In FIG. 5(a), an ITO substrate 50 is first provided and preferably used as a top structure of a 4-wire or 8-wire resistive touch panel; an ITO conductive film layer 50a formed thereon is managed in advance for an active area AA and a frame area FA. FIG. 5(a) shows the back side of the ITO substrates 50.

In FIG. 5(b), the ITO conductive film layer 50a on an area of the frame area FA that is managed to form a conductive film layer thereon is removed by an etching process. The transparent substrate layer beneath is exposed and a removed area 52 is formed.

In FIG. 5(c), a dielectric film layer 51 is formed on the frame area FA near edges of the ITO substrate 50 by a process including one of the screen printing process, the transfer printing process, the inkjet printing process, and the plating process. When the dielectric film layer 51 was printed on top of the ITO conductive film layer 50a, the remaining portion of the ITO conductive film layer 50a uncovered by the dielectric film layer 51 comprises the active area AA and the removed area 52. The pattern of the dielectric film layer 51 is managed to expose the removed area 52 when designing the dielectric film layer 51.

In FIG. 5(d), a conductive film layer 53 is formed for defining an active area AA and a frame area FA in a scope larger than the removed area 52 by a process including one of the screen printing process, the transfer printing process, the inkjet printing process and the plating process. The conductive film layer 53 is rendered to cover and have contact with the ITO conductive film layer 50a on top of the active area AA and the ITO conductive film layer 50a on the active area AA is rendered to be electrically coupled to the conductive film layer 53. It is to be noticed that the dielectric film layer 51 and the conductive film layer 53 are opaque and have thin film materials with the same color. Preferably, the dielectric film layer 51 and the conductive film layer 53 are a colored dielectric ink and a colored conductive ink having the same color code respectively.

When both of the dielectric film layer 51 and the conductive film layer 53 were printed, the trace or the circuit required for the 4-wire or 8-wire resistive touch panel can be disposed on the frame area FA which comprises the dielectric film layer 51 and the conductive film layer 53. When the ITO substrate 50 was assembled on the touch panel, the trace or the circuit required for the 4-wire or 8-wire resistive touch panel configured on the dielectric film layer 51 and the conductive film layer 53 can be sheltered by the colored dielectric film layer 51 and the conductive film layer 53, and they will not be seen on the appearance. The final appearance of the front of the ITO substrate 50 is orderly and clearly divided into an active area AA and a frame area FA as shown in FIG. 13(a).

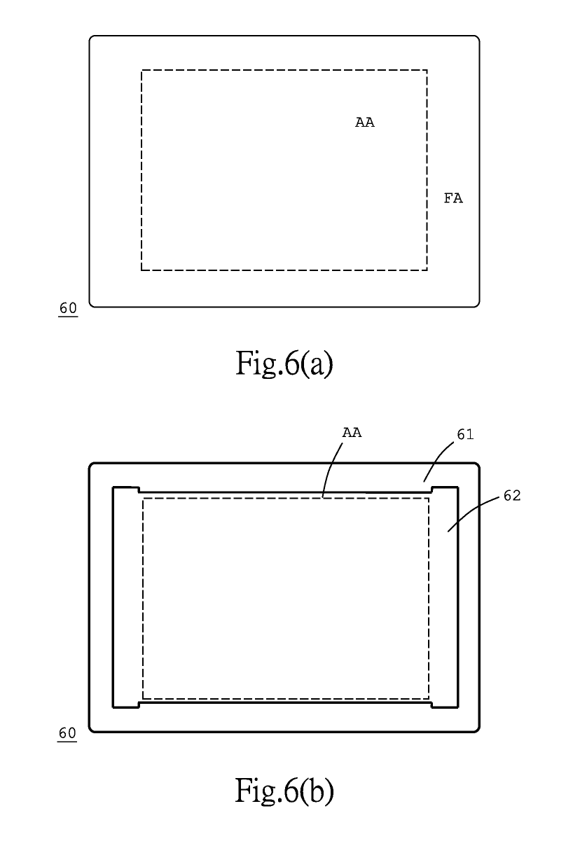

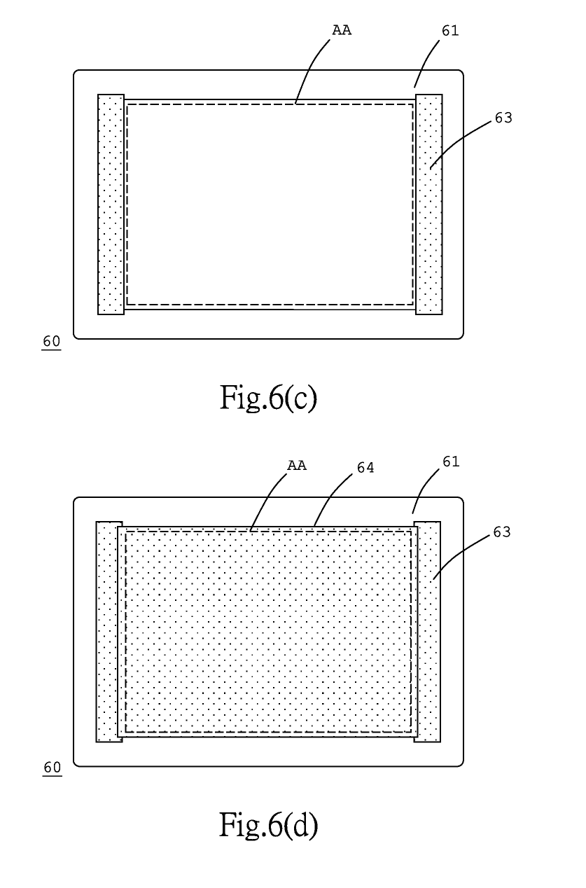

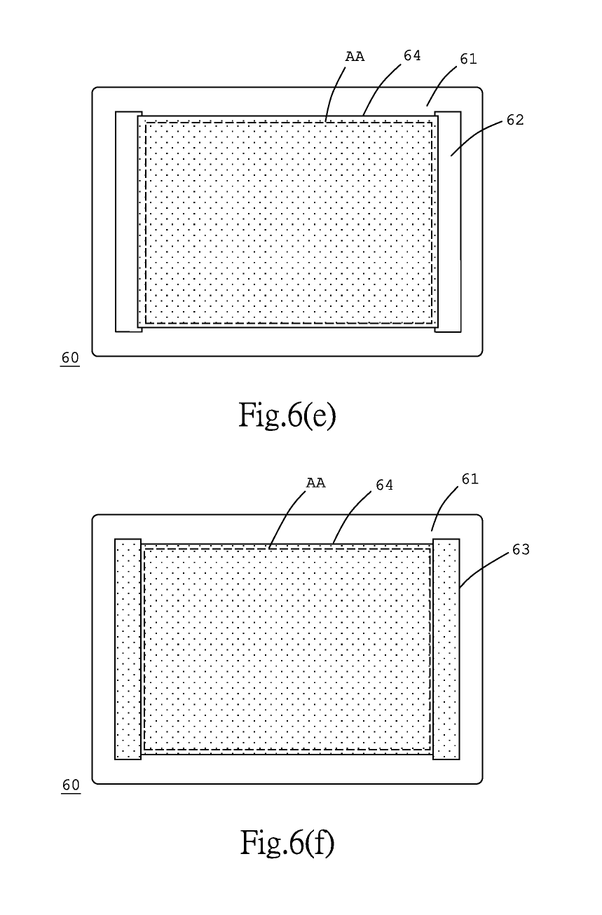

Please refer to FIGS. 6(a) to 6(d), which illustrate the third embodiment in accordance with the present invention. In FIG. 6(a), a dielectric substrate 60 is first provided and preferably used as a top structure of a 4-wire or 8-wire resistive touch panel and its surface is managed in advance for an active area AA and a frame area FA. The FIG. 6(a) shows the back side of the dielectric substrates 60.

In FIG. 6(b), a dielectric film layer 61 is formed on the frame area FA near edges of the dielectric substrate 60 by a process including one of the screen printing process, the transfer printing process, the inkjet printing process and the plating process. When the dielectric film layer 61 was printed on top of the dielectric layer 60, the remaining portion of the dielectric layer 60 uncovered by the dielectric film layer 61 comprises the active area AA and a conductive area 62. The pattern of the dielectric film layer 61 is managed to expose the conductive area 62 when designing the dielectric film layer 61.

In FIG. 6(c), a conductive film layer 63 is formed on the conductive area 62 as shown in FIG. 6(b) to define an active area AA and a frame area FA by a process including one of the screen printing process, the transfer printing process, the inkjet printing process, and the plating process. It is to be noticed that the dielectric film layer 61 and the conductive film layer 63 are opaque and have thin film materials with the same colors which are preferably a colored dielectric ink and a colored conductive ink having the same color code respectively. The trace or the circuit required for the 4-wire or 8-wire resistive touch panel can be disposed on the frame area FA, which comprises the dielectric film layer 61 and the conductive film layer 63.

In FIG. 6(d), a transparent conductive layer 64 covering the active area AA and having contact with the conductive film layer 63 is formed in a range larger than the active area AA and capable of overlapping the conductive film layer 63 by a process including one of spinning coating, transfer printing, inkjet printing, and evaporation. The appearance of the front of the dielectric substrate 60 as shown in FIG. 13(a) is orderly divided into the active area AA and the frame area FA.

It is to be noticed that the step of forming the conductive film layer 63 corresponding to FIG. 6(c) and the step of forming the transparent conductive layer 64 corresponding to FIG. 6(d) in the third embodiments are switchable, i.e. the transparent conductive layer 64 can be formed before forming the conductive film layer 63 in the process, i.e. the priority of the steps is not limited.

Please refer to FIG. 6(e), which illustrates a variant of the third embodiment. Following the process in FIG. 6(b), a transparent conductive layer 64 covering the active area AA is formed in a range larger than the active area AA by a process including one of spinning coating, transfer printing, inkjet printing, and evaporation.

In FIG. 6(f), a conductive film layer 63 is formed in a range larger than the conductive area 62 shown in FIG. 6(b) and capable of overlapping the transparent conductive layer 64 to define an active area AA and a frame area FA by a process including one of the screen printing process, the transfer printing process, the inkjet printing process, and the plating process. It is to be noticed that the dielectric film layer 61 and the conductive film layer 63 are opaque and have thin film materials with the same colors. Preferably, the dielectric film layer 61 and the conductive film layer 63 are colored dielectric ink and colored conductive ink having the same color code respectively.

The trace or the circuit required for the 4-wire or 8-wire resistive touch panel can be disposed on the frame area FA, which comprises the dielectric film layer 61 and the conductive film layer 63. The appearance of the front of the dielectric substrate 60 as shown in FIG. 13(a) is orderly divided into the active area AA and the frame area FA.

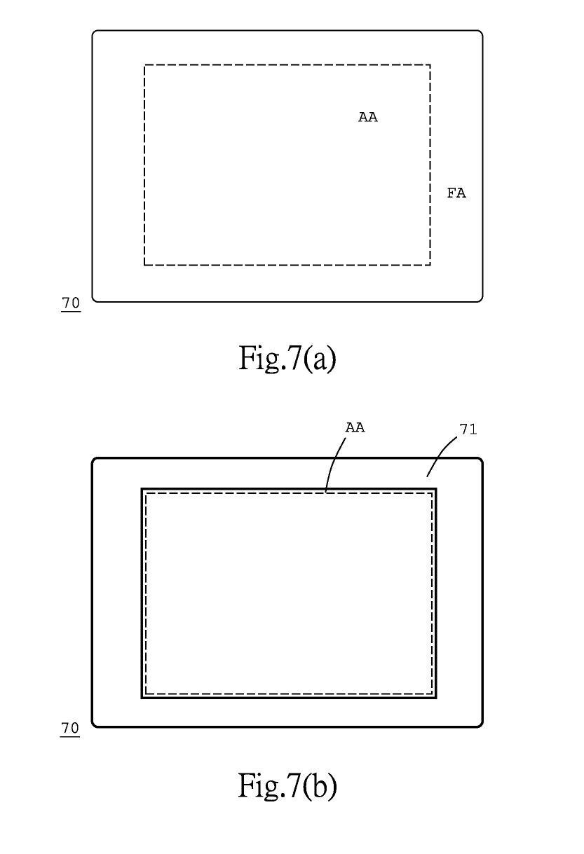

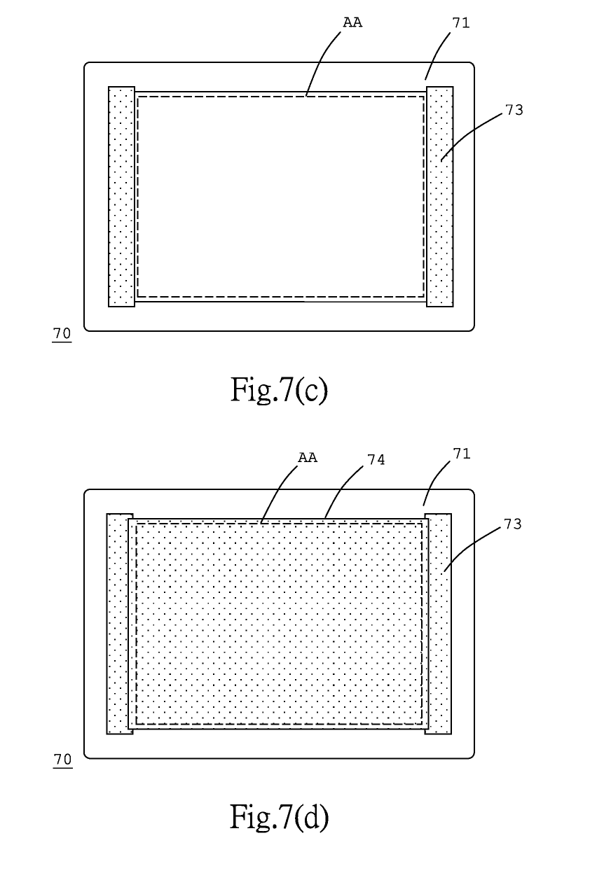

Please refer to FIGS. 7(a) to 7(d), which illustrate the fourth embodiment in accordance with the present invention. In FIG. 7(a), a dielectric substrate 70 is provided and preferably used as a top structure of a 4-wire or 8-wire resistive touch panel and its surface is managed in advance for an active area AA and a frame area FA. FIG. 7(a) shows the back side of the dielectric substrate 70.

In FIG. 7(b), a dielectric film layer 71 is formed on the frame area FA near edges of the dielectric substrate 70 by a process including one of the screen printing process, the transfer printing process, the inkjet printing process, and the plating process. The difference between the fourth embodiment and the third embodiment is that the dielectric film layer 61 does not cover all the frame area FA in the third embodiment, wherein its pattern is managed in a form of being capable of exposing the conductive area 62 inside the frame area FA. But the dielectric film layer 71 covers all the frame area FA and does not expose the conductive area 62 inside the frame area FA in the fourth embodiment.

In FIG. 7(c), a conductive film layer 73 is formed on the conductive area 62 as shown in FIG. 6(b) to define an active area AA and a frame area FA by a process including one of the screen printing process, the transfer printing process, the inkjet printing process, and the plating process. It is to be noticed that the dielectric film layer 71 and the conductive film layer 73 have thin film materials with the same colors preferably. However, it is not necessary for the dielectric film layer 71 and the conductive film layer 73 to be a colored dielectric ink and a colored conductive ink having the same color code respectively, i.e. it is unnecessary for the dielectric film layer 71 and the conductive film layer 73 to match the color. The trace or the circuit required for the 4-wire or 8-wire resistive touch panel can be disposed on the frame area FA, which comprises the dielectric film layer 71 and the conductive film layer 73.

In FIG. 7(d), a transparent conductive layer 74 covering the active area AA and having contact with the conductive film layer 73 is formed in a range larger than the active area AA and capable of overlapping the conductive film layer 73 by a process including one of the spin-on coating process, the transfer printing process, the inkjet printing process, and the evaporation process. The appearance of the front of the dielectric substrate 70 as shown in FIG. 13(a) is orderly divided into the active area AA and the frame area FA. It is to be noticed that the step of forming the conductive film layer 73 corresponding to FIG. 7(c) and the step of forming the transparent conductive layer 74 corresponding to FIG. 7(d) in the fourth embodiments are switchable, i.e. the transparent conductive layer 74 can be formed before forming the conductive film layer 73 in the process, i.e. the priority of the steps is not limited as disclosed in FIG. 6(e) to FIG. 6(f) of the third embodiment.

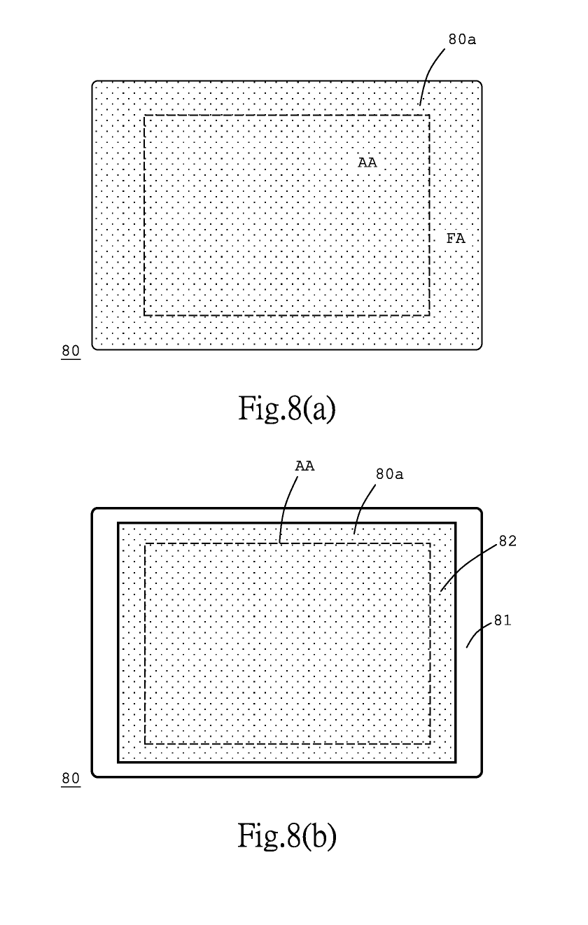

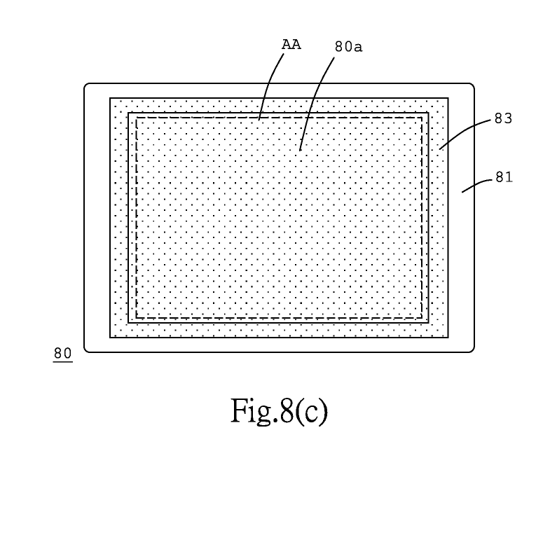

Please refer to FIGS. 8(a) to 8(c), which illustrate the fifth embodiment in accordance with the present invention. In FIG. 8(a), an ITO substrate 80 is first provided and preferably used as a top structure of a 5-wire resistive touch panel and its surface is managed in advance for an active area AA and a frame area FA. FIG. 8(a) shows the back side of the ITO substrates 80.

In FIG. 8(b), a dielectric film layer 81 is formed on the frame area FA near edges of the ITO substrate 80, especially on the outside frame of the frame area FA adjacent to edges, by a process including one of the screen printing process, the transfer printing process, the inkjet printing process, and the plating process. When the dielectric film layer 81 was printed on top of the ITO conductive film layer 80a, the remaining portion of the ITO conductive film layer 80a uncovered by the dielectric film layer 81 comprises the active area AA and a conductive area 82. The pattern of the dielectric film layer 81 is managed to expose the conductive area 82 when designing the dielectric film layer 81.

It is to be noticed that the pattern of the dielectric film layer 81 can refer to the planning to the pattern of the dielectric film layer 71 in the fourth embodiment, i.e. the pattern of the dielectric film layer 81 can be planned as a form of being capable of covering all the frame area FA and not exposing the conductive area 82 inside the frame area FA.

In FIG. 8(c), a conductive film layer 83 is formed on the conductive area 82 to define an active area AA and a frame area FA by a process including one of the screen printing process, the transfer printing process, the inkjet printing process and the plating process. The dielectric film layer 81 and the conductive film layer 83 are colored dielectric ink and colored conductive ink having the same color code respectively. When the dielectric film layer 81 and the conductive film layer 83 were printed, the trace or the circuit required for the 5-wire resistive touch panel can be disposed on the frame area FA which comprises the dielectric film layer 81 and the conductive film layer 83 such as a circuit of detecting layer. The final appearance of the front of the ITO substrate 80, i.e. the front of the top structure of the 5-wire resistive touch panel which faces the user, is orderly divided into an active area AA and a frame area FA as shown in FIG. 13(a).

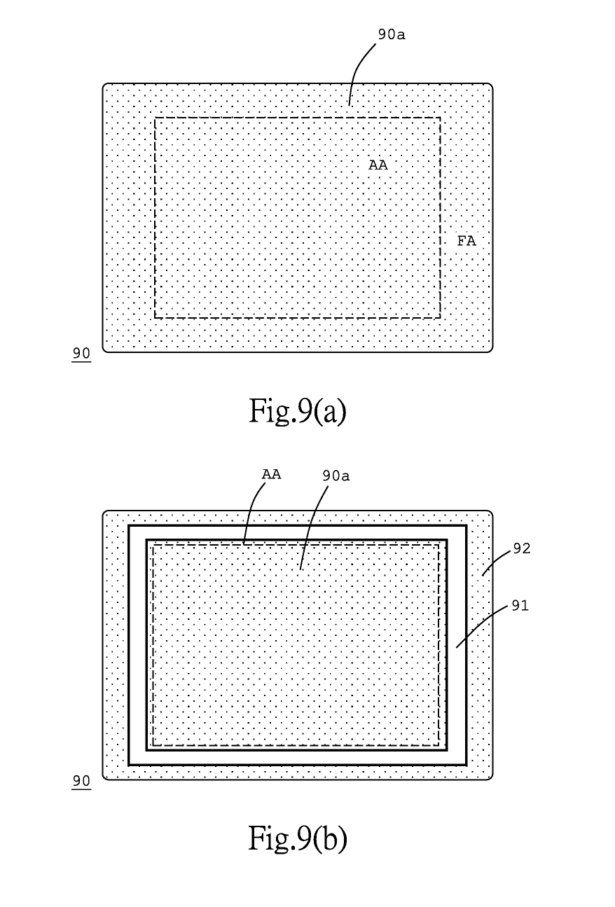

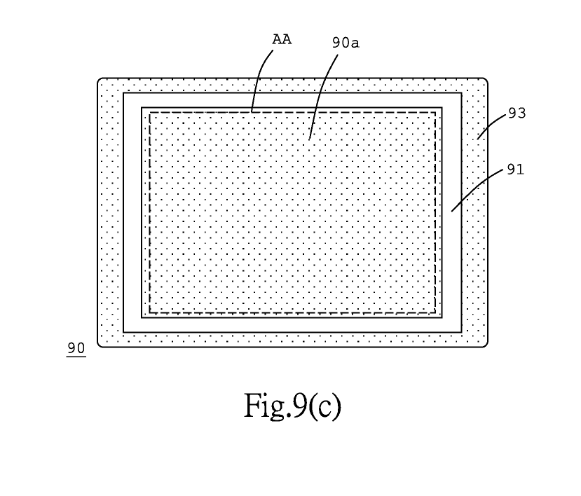

Please refer to FIGS. 9(a) to 9(c), which illustrate the sixth embodiment in accordance with the present invention. The difference between the sixth embodiment and the fifth embodiment is that the dielectric film layer 81 is disposed on the outside frame of the frame area FA adjacent to the edges in the fifth embodiment. However, the dielectric film layer 81 is disposed on the inside frame of the frame area FA in the sixth embodiment.

In FIG. 9(a), an ITO substrate 90 is first provided and the ITO conductive film layer 90a formed thereon is managed for an active area AA and a frame area FA in advance. In FIG. 9(b), a dielectric film layer 91 is formed on the frame area FA near edges of the ITO substrate 90, especially on the inside frame of the frame area FA adjacent to the active area AA, and a conductive area 92 is exposed by a process including one of the screen printing process, the transfer printing process, the inkjet printing process, and the plating process. It is to be noticed that the pattern of the dielectric film layer 91 can refer to the planning of the pattern of the dielectric film layer 71 in the fourth embodiment, i.e. the pattern of the dielectric film layer 91 can be planned as being capable of covering all the frame area FA and not exposing the conductive area 92 inside the frame area FA.

In FIG. 9(c), a conductive film layer 93 is formed on the conductive area 92 as shown in FIG. 9(b) to define an active area AA and a frame area FA by a process including one of the screen printing process, the transfer printing process, the inkjet printing process and the plating process. The dielectric film layer 91 and the conductive film layer 93 are preferably a colored dielectric ink and a colored conductive ink having the same color code respectively. The final appearance of the front of the ITO substrate 90 is orderly divided into an active area AA and a frame area FA as shown in FIG. 13(a).

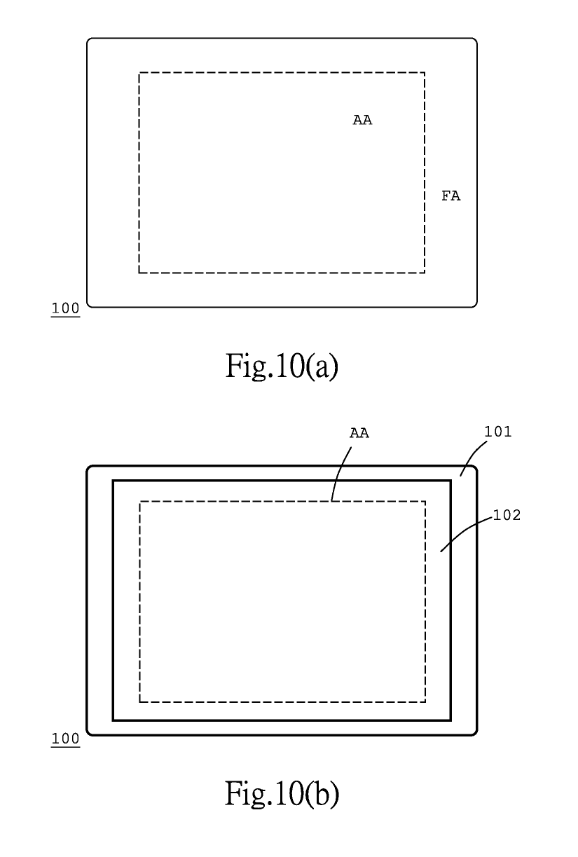

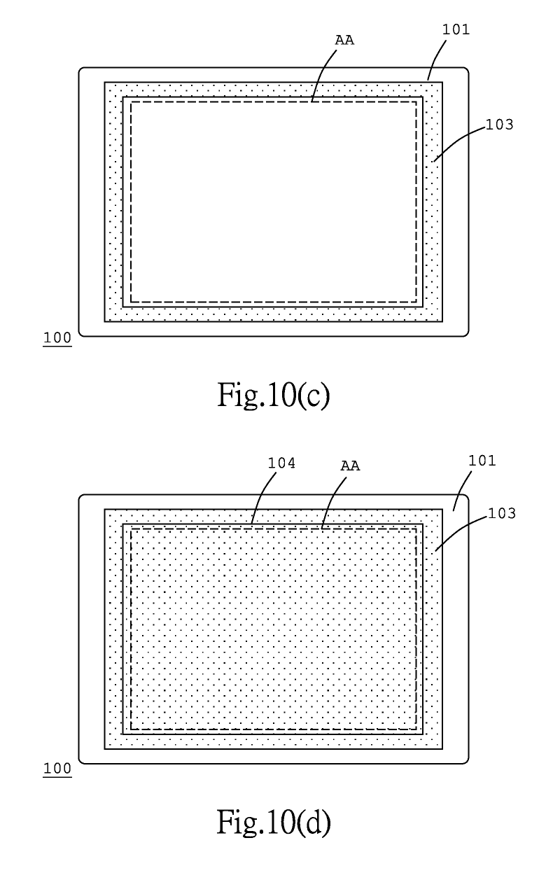

Please refer to FIGS. 10(a) to 10(d), which illustrate the seventh embodiment in accordance with the present invention. In FIG. 10(a), a dielectric substrate 100 is first provided and preferably used as a top structure of a 5-wire resistive touch panel, and its surface is managed in advance for an active area AA and a frame area FA. FIG. 10(a) shows the back side of the dielectric substrates 100.

In FIG. 10(b), a dielectric film layer 101 is formed on the frame area FA near edges of the dielectric substrate 100 by a process including one of the screen printing process, the transfer printing process, the inkjet printing process, and the plating process. When the dielectric film layer 101 was printed on top of the dielectric substrate 100, the remaining portion of the dielectric substrate 100 uncovered by the dielectric film layer 101 comprises the active area AA and a conductive area 102. The pattern of the dielectric film layer 101 is managed to expose the conductive area 102 when designing the dielectric film layer 101.

In FIG. 10(c), a conductive film layer 103 is formed on the conductive area 102 to define an active area AA and a frame area FA by a process including one of the screen printing process, the transfer printing process, the inkjet printing process, and the plating process. The dielectric film layer 101 and the conductive film layer 103 are a colored dielectric ink and a colored conductive ink having the same color code respectively.

In FIG. 10(d), a transparent conductive layer 104 covering the active area AA and having contact with the conductive film layer 103 is formed in a range larger than the active area AA and capable of overlapping the conductive film layer 103 by a process including one of spinning coating, transfer printing, inkjet printing, and evaporation. The conductive film layer 103 is rendered to be electrically coupled to the transparent conductive layer 104 on the active area AA. When the dielectric film layer 101 and the conductive film layer 103 were printed, the trace or the circuit required for the 5-wire resistive touch panel can be disposed on the frame area FA which comprises the dielectric film layer 101 and the conductive film layer 103 such as a circuit of detecting layer. The final appearance of the front of the dielectric substrate 100 is orderly divided into an active area AA and a frame area FA as shown in FIG. 13(a).

It is to be noticed that the step of forming the conductive film layer 103 corresponding to FIG. 10(c) and the step of forming the transparent conductive layer 104 corresponding to FIG. 10(d) in the seventh embodiments are switchable, i.e. the transparent conductive layer 104 can be formed before forming the conductive film layer 103 in the process, i.e. the priority of the steps is not limited as disclosed in FIG. 6(e) to FIG. 6(f) of the third embodiment.

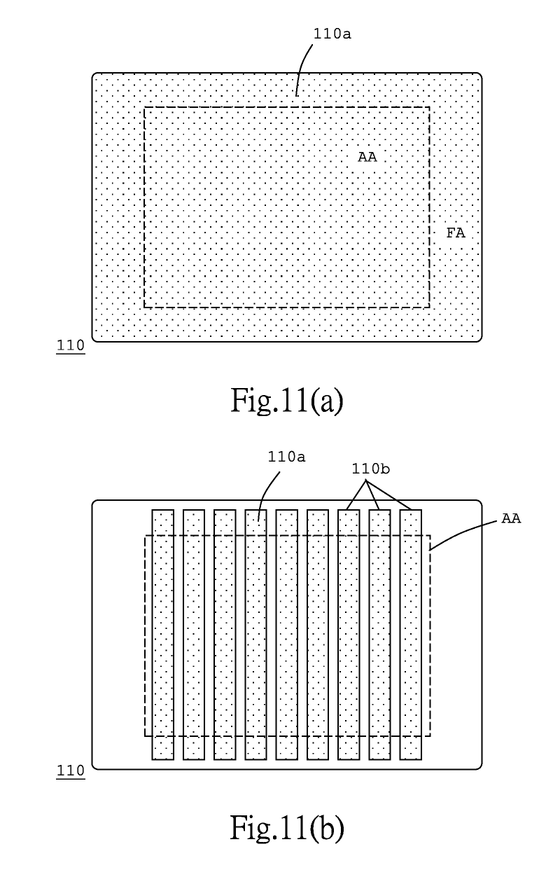

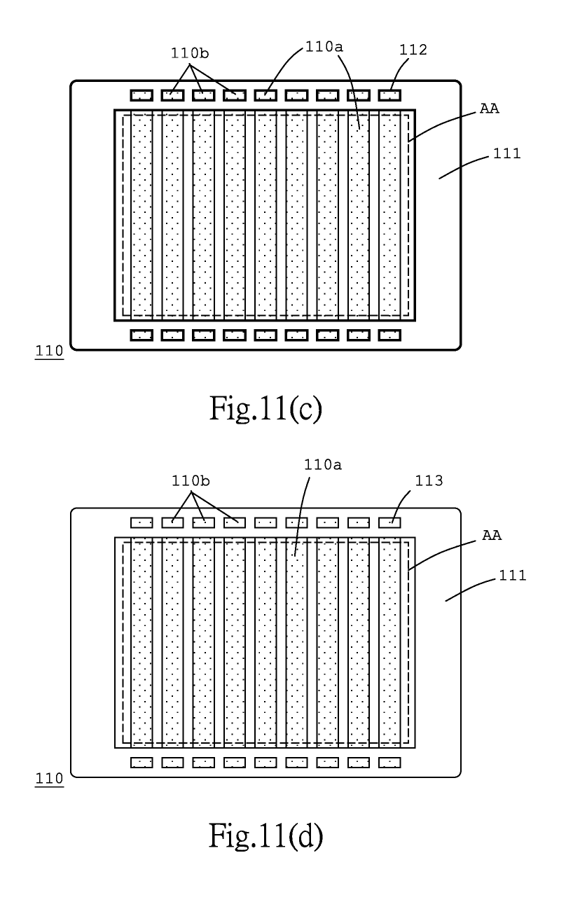

Please refer to FIGS. 11(a) to 11(d), which illustrate the eighth embodiment in accordance with the present invention. The present invention can be applied to multi-touch panels. In FIG. 11(a), an ITO substrate 110 is provided and preferably used as a top structure of a multi-touch projective capacitive panel or a multi-touch resistive panel. The ITO conductive film layer 110a formed thereon is managed for an active area AA and a frame area FA in advance. The FIG. 11(a) shows the back side of the ITO substrates 110.

In FIGS. 11(b), the ITO conductive film layer 110a on the ITO substrate 110 is patterned to remove the residual ITO conductive film layer 110a by an etching process. The ITO conductive film layer 110a is rendered to form into striped electrodes 110b in rectangle as a plurality of sensing electrodes of the multi-touch panel.

In FIG. 11(c), a dielectric film layer 111 is formed on top of the ITO conductive film layer 110a of the ITO substrate 110 and on the frame area FA near edges of the ITO substrate 110 to define an active area AA and a frame area FA by a process including one of the screen printing process, the transfer printing process, the inkjet printing process and the plating process. The form of the dielectric film layer 111 comprises a plurality of hollow area 112 with openings for exposing the ends of the striped electrodes 110b. It is to be noticed that the pattern of the dielectric film layer 111 is managed to leave in a form of a plurality of hollow areas 112 when designing the dielectric film layer 111. The openings are hollow spaces, and the dielectric film layer 111 of the opaque area (e.g., layer(s) being opaque in the frame area) includes at least one hollow space above at least a corresponding one of the striped electrodes 110Ab.

In FIG. 11(d), a conductive film layer 113 is formed in a range larger than the hollow area 112 by a process including one of the screen printing process, the transfer printing process, the inkjet printing process, and the plating process. The dielectric film layer 111 and the conductive film layer 113 are preferably a colored dielectric ink and a colored conductive ink having the same color code respectively. The conductive film layer 113 is electrically coupled to striped electrodes 110b on the active area AA. For example, the conductive film layer 113 includes a number of connection pads; each of the connection pads is disposed over one of the hollow spaces and electrically coupled to the corresponding one of the striped electrodes 110b. When the dielectric film layer 111 and the conductive film layer 113 were printed, the trace or the circuit required for the touch panels can be disposed on the frame area FA, which comprises the dielectric film layer 111 and the conductive film layer 113 such as a circuit of detecting layer. The final appearance of the front of the dielectric substrate 110 is orderly divided into an active area AA and a frame area FA as shown in FIG. 13(a).

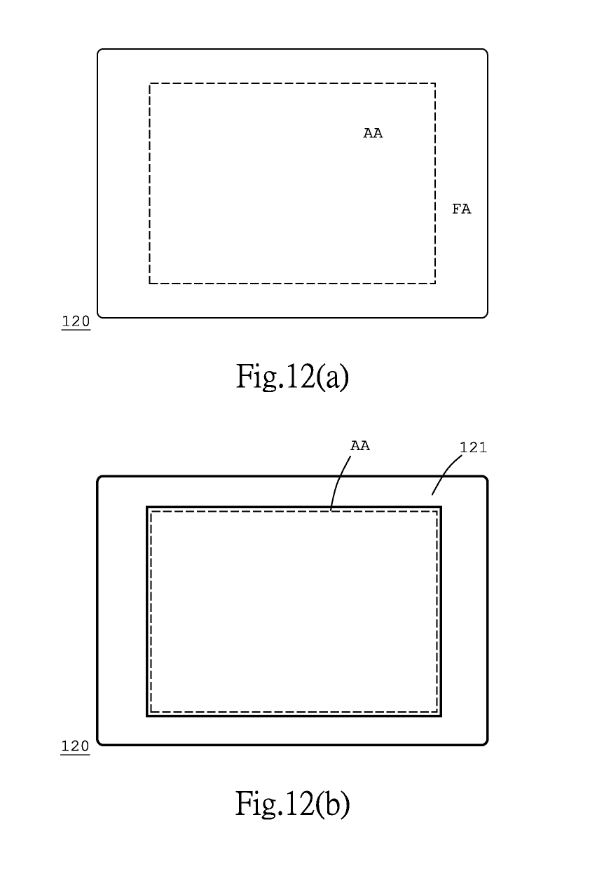

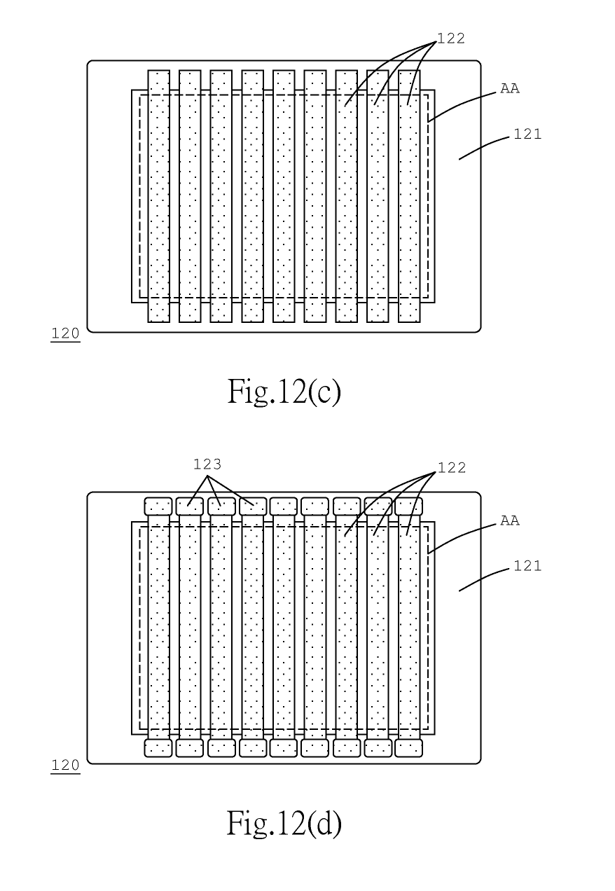

Please refer to FIGS. 12(a) to 12(d), which illustrate the ninth embodiment in accordance with the present invention. In FIG. 12(a), a dielectric substrate 120 is first provided and preferably used as a top structure of a multi-touch projective capacitive panel or a multi-touch resistive panel. The surface of the dielectric substrate 120 is managed for an active area AA and a frame area FA in advance. FIG. 12(a) shows the back side of the dielectric substrates 120.

In FIG. 12(b), a dielectric film layer 121 is formed on the frame area FA near edges of the dielectric substrate 120 by a process including one of the screen printing process, the transfer printing process, the inkjet printing process, and the plating process. The dielectric film layer 121 covers the frame area FA and the remaining portion of the dielectric substrate 120 uncovered by the dielectric film layer 121 comprises the active area AA

In FIG. 12(c), the striped transparent conductive layers 122 of the dielectric film layer 121 on the frame area covering the active area AA are formed for striped electrodes by a process including one of spinning coating, transfer printing, inkjet printing, and evaporation. Preferably, striped transparent conductive layers 122 are ITO materials. In addition, the striped transparent conductive layers 122 can be regarded as a transparent conductive layer includes a plurality of striped electrodes.

In FIG. 12(d), a conductive film layer 123 is formed on both ends of each of the striped transparent conductive layers 122 for lapping pads of each of the striped transparent conductive layers 122 by a process including one of the screen printing process, the transfer printing process, the inkjet printing process and the plating process. For example, the conductive film layer 123 includes a number of connection pads; each of the connection pads is disposed over and electrically coupled to the corresponding one of the striped electrodes. It is to be noticed that the dielectric film layer 121 and the conductive film layer 123 have thin film materials with the same colors preferably. But it is not necessary for the dielectric film layer 121 and the conductive film layer 123 to be a colored dielectric ink and a colored conductive ink having the same color code respectively, i.e. it is unnecessary for the dielectric film layer 121 and the conductive film layer 123 to match the color. The final appearance of the front of the dielectric substrate 120 is orderly divided into an active area AA and a frame area FA as shown in FIG. 13(a).

It is to be noticed that the step of forming striped transparent conductive layers 122 as striped electrodes corresponding to FIG. 12(c) and the step of forming the conductive film layer 123 for a lapping pad of each of the striped transparent conductive layers 122 corresponding to FIG. 12(d) in the ninth embodiments are switchable, i.e. the conductive film layer 123 for a lapping pad of each of the striped transparent conductive layers 122 can be formed first and then striped transparent conductive layers 122 as striped electrodes can be formed on the lapping pads in the process, i.e. the priority of the steps is not limited.

It is to be noticed that the order of the step of forming a dielectric film layer and the step of forming a conductive film layer thereafter in the aforementioned embodiments including the first embodiment to the ninth embodiment are switchable, i.e. the conductive film layer can be formed after the dielectric film layer, i.e. the priority of the steps is not limited.

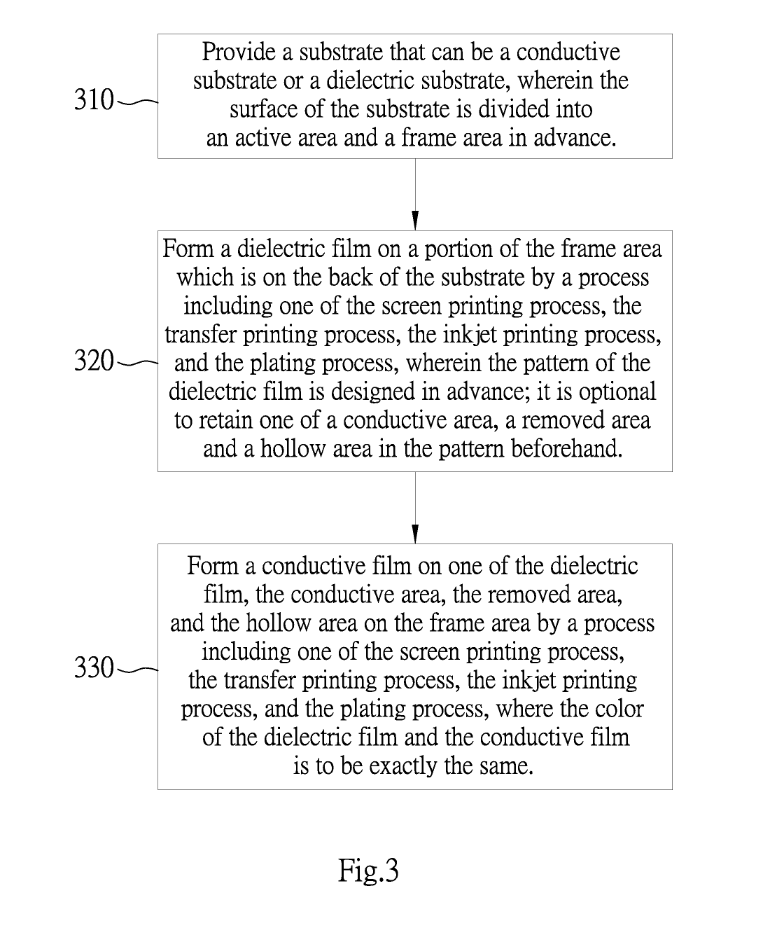

Please refer to FIG. 3, which is a flow chart illustrating the method for manufacturing the substrate structure for the touch panel in accordance with the present invention. The present invention provides a method for manufacturing the substrate structure for the touch panel by concluding the aforementioned embodiments, wherein the method comprises the following steps. Step 310 is to provide a substrate that can be a conductive substrate or a dielectric substrate, wherein the surface of the substrate is divided into an active area and a frame area in advance. Step 320 is to form a dielectric film on a portion of the frame area which is on the back of the substrate by a process including one of the screen printing process, the transfer printing process, the inkjet printing process, and the plating process, wherein the pattern of the dielectric film is designed in advance; it is optional to retain one of a conductive area, a removed area and a hollow area in the pattern beforehand. Step 330 is to form a conductive film on one of the dielectric film, the conductive area, the removed area, and the hollow area on the frame area by a process including one of the screen printing process, the transfer printing process, the inkjet printing process, and the plating process, where the color of the dielectric film and the conductive film is to be exactly the same. It is to be noticed that when the colors of the dielectric film and the conductive film are exactly the same, a flat, slim, beautiful, succinct, and neat appearance will appear on the front of the substrate.

Referring to FIGS. 13(b) to 13(d), some embodiments of a portion of a top layer for a touch panel are illustrated in the cross-sectional views. As shown in FIGS. 13(b) to 13(d), a top layer of a touch panel is formed and can be used to realize the top layer according to the first to the eighth embodiments, as exemplified above. For example, in FIG. 13(b), a dielectric substrate 130 is provided and a dielectric film layer 131 is formed on the dielectric substrate 130 so as to define the active area AA by the uncovered area of the dielectric substrate 130, and a conductive film layer 132 is then formed on a portion of the dielectric film layer 131. In particular, the conductive film layer 132 covers the portion of the dielectric film layer 131 and the dielectric substrate 130 at an edge of the dielectric film layer 131 toward the active area. In FIG. 13(c), the conductive film layer 132 covers another portion of the dielectric film layer 131 and the dielectric substrate 130 at an edge of the dielectric film layer 131 on the edge of the frame area. In FIG. 13(d), the dielectric film layer 131 may have opening such that the conductive film layer 132 also covers a portion of the dielectric film layer 131 and the dielectric substrate 130 at an area of the dielectric film layer 131 of the frame area.

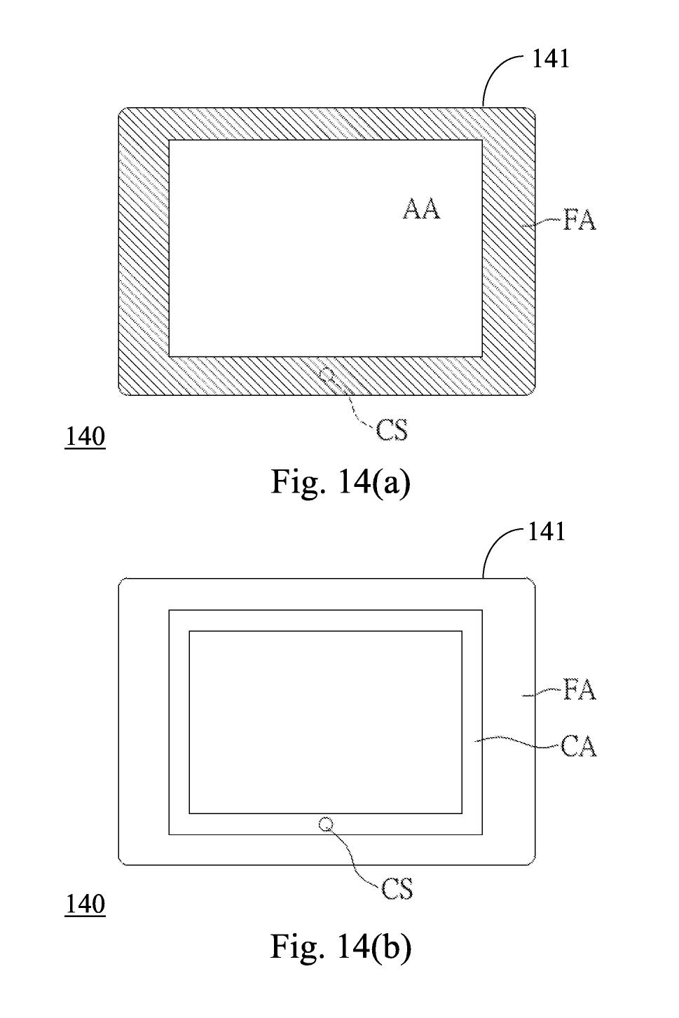

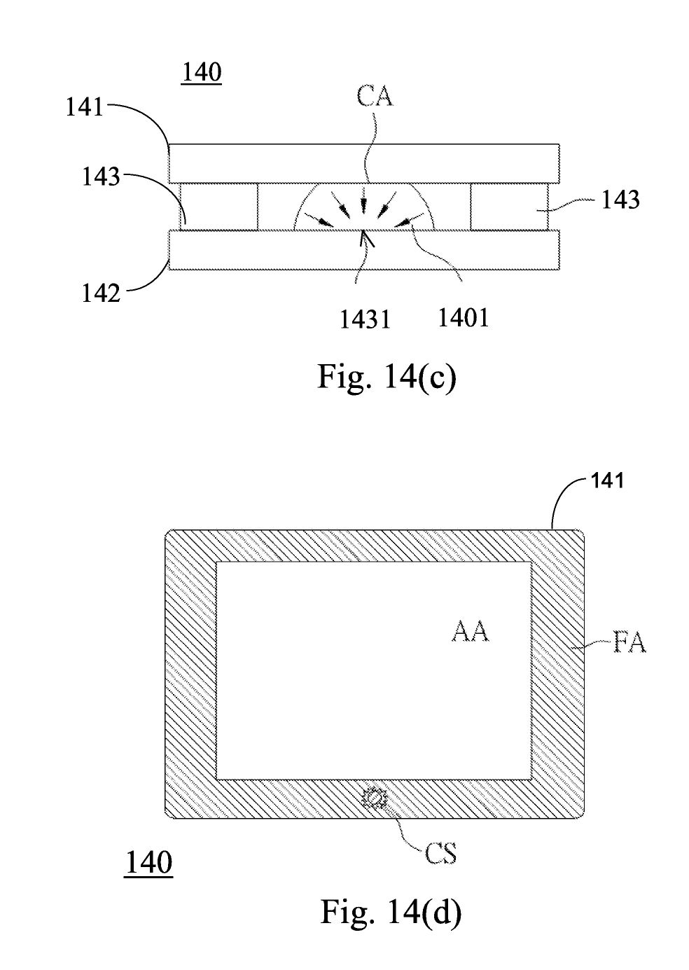

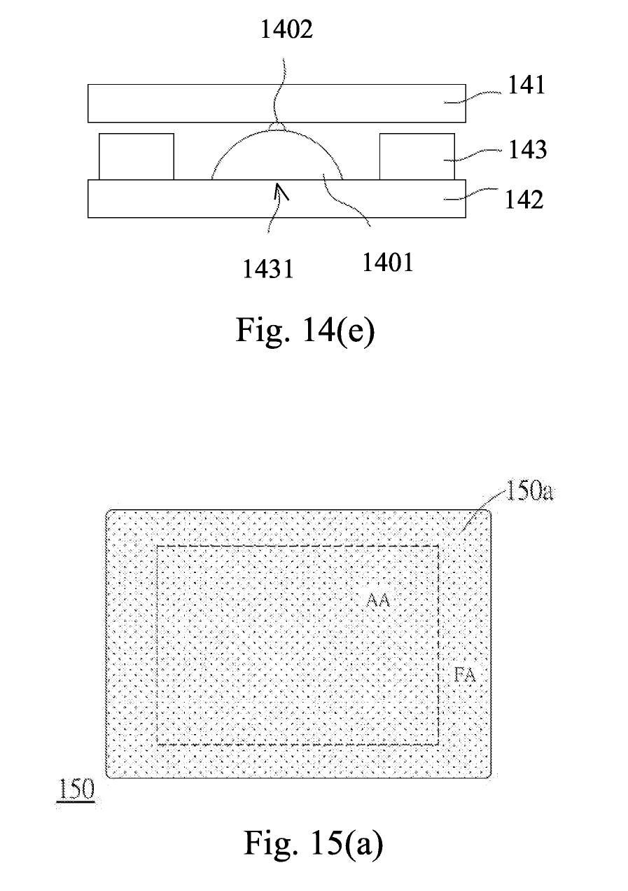

Further, electrical connection between a top structure and a bottom structure of a touch panel are illustrated in the following embodiments. Referring to FIGS. 14(a) to 14(e), a top structure and a bottom structure of a touch panel, for example, a resistive touch panel, are concerned. In particular, FIGS. 14(e) leads to a touch panel with a stable and reliable electrical connection between its top structure and bottom structure.

Referring to FIG. 14(a), a top structure 141 of a touch panel 140 is illustrated, which is realized according one of the embodiments of the invention. The surface of the touch panel 140 is typically divided into three areas: an active area, a frame area FA and an un-insulated area within FA when it is viewed from the front. The active area, or AA, is used to receive the user's touch for input, the frame area, or FA, is used for hiding the wires and the circuits inside the touch panel. In FIG. 14(b) shows the rear view of the top structure 141 of the touch panel 140. Within the frame area FA, there is a conductive area CA. In order for transmitting the signal from the top ITO substrate to the bottom ITO substrate, one or more locations corresponding to electrodes of the circuits inside the touch panel are reserved for making contacts points. For example, the conductive area CA has a location for making one or more contact points, such as a conductive bump CS, to be disposed between the top structure 140 and a bottom structure of the touch panel.

Referring to FIG. 14(c), a side view of the layer structure of the touch panel 140 is illustrated. The touch panel 140 in FIG. 14(c) includes the top structure 140, a bottom structure 142, and an insulation layer 143. The insulation layer 143, for example, a dielectric adhesive layer, has one or more vias, such as a via 1431, corresponding to the location(s) on the conductive area CA of the top structure 141, as discussed above, for making one or more contacts points for electrical connection so as to facilitate signal transmission between the top structure 140 and the bottom structure 142. The bottom structure 142, for example, includes a second substrate and a transparent conductive layer disposed on the second substrate.

In one example, the electrical connection can be made by making a contact by forming a conductive bump. Referring to FIG. 14(c), a contact is made by forming a first conductive bump 1401 using a conductive glue, e.g., applying or dispensing one or a few drops of silver glue to a location of the bottom structure 142 corresponding to the via 1431. After the conductive glue is applied or dispensed, the top structure 141 is superimposed on the bottom structure 142 so that the first conductive bump 1401 contacts the top structure 141, e.g., a location on the conductive area CA of the top structure 141 for signal transmission. The top structure 141 and the bottom structure 142 are then adhered by performing a thermal curing process.

However, regarding the above example, the applicant finds that during the thermal curing process, the cohesive force of the silver glue causes itself to shrink in size. The shrinkage may cause flaking off of the printed circuits and the part of the conductive area that are in contact with the first conductive bump 1401, as illustrated in FIG. 14(d) which shows the rear side of the top structure 140 after the thermal curing process. Hence the defective rate is high. In addition, it is found that decreasing the size of the silver glue dispensation cannot resolve this problem; and if the volume of the silver glue is not adequate, the connectivity will be poor and hence the poor conductivity for the signal transmission between the top structure 141 and the bottom structure 142.

Referring to FIG. 14(e), a touch panel according to the tenth embodiment is illustrated wherein electrical connection is made so as to facilitate signal transmission between its top structure and bottom structure. For the sake of illustration, the touch panel 140 is taken as an example for the tenth embodiment, but the implementation of this embodiment is not limited to the touch panel. The present tenth embodiment is applicable to any kinds of resistive touch panels, capacitive touch panels, and electromagnetic touch panels.

Referring to FIG. 14(e), the touch panel 140 includes the top structure 140, the bottom structure 142, the insulation layer 143, and a plurality of conductive bumps. The top structure 141 provides an active area AA and a frame area FA, as illustrated in FIG. 14(a), and includes a layer structure including one or more electrodes disposed thereon, illustrated as an upper structure in any one of the embodiments according to the invention. The insulation layer 143 has at least one via, such as the via 1431, and is disposed between the top structure 141 and the bottom structure 142. For example, the plurality of the conductive bumps include a first conductive bump 1401 and a second conductive bump 1402. The first conductive bump 1401 is disposed within one of the at least one via, such as the via 1431, and is in contact with or electrically coupled to the bottom structure 142, for example, at least one electrode of the second transparent conductive layer. The second conductive bump 1402 is disposed within the one of the at least one via, such as the via 1431, and is in contact with or electrically coupled to the first conductive bump 1401 and one of the electrodes of the top structure 141, such as a location of the conductive area CA of the top structure 141 where an electrode is located.

In addition, referring to FIG. 14(e), the touch panel 140 is formed as following to facilitate signal transmission between its top structure and bottom structure. First, the bottom structure 142 is provided. The insulated layer 141 is then formed on top of the bottom structure 142 wherein there is one or more vias, such as the opening (via 1431) is left uninsulated. A first conductive bump 1401 is formed by using a conductive glue, e.g., applying or dispensing one or a few drops of silver glue to a location of the bottom structure 142 corresponding to the via 1431. Then the bottom structure 142 is under a thermal curing process to solidify the conductive glue, thus forming the first conductive bump 1401. After that, a second conductive bump 1402 is formed on the first conductive bump 1401 by using a conductive glue, e.g., applying or dispensing one or a few drops of the silver glue to the first conductive bump 1401 wherein the size (or amount) of the drop(s) of the conductive glue for forming the second conductive bump 1402 is smaller than that of the first conductive bump 1401. The top structure 141 is then provided which is placed on top of the bottom structure 142, followed by a thermal curing process to solidify the second conductive bump 1402 formed on the first conductive 1401.

Since the size of the second conductive bump 1402, or the amount of the drop(s) of the conductive glue, is smaller than or much small than that of the first conductive bump 1401, the shrinkage of the second conductive bump 1402 is relatively much smaller than that of the first conductive bump 1401. In addition, the bigger base of contact of the first conductive bump 1401 ensures a stable conductivity for signal transmission from the second conductive bump 1402. Further, the smaller size of the second conductive bump 1402 avoids flaking off of the printed circuits and a part of the conductive area that are in contact with the second conductive bump 1402 of the top dielectric substrate 145 after the thermal curing process. In an example, the first conductive bump 1401 and the second conductive bump 1402 are formed with the same conductive material, the combination of the at least two conductive bumps is good and hence a stable conductivity between the top and the bottom substrates is obtained. In other examples, two or more conductive bumps can be formed within a via in a similar way according to the above embodiment. Further, the conductive bumps may be made by a conductive coating.

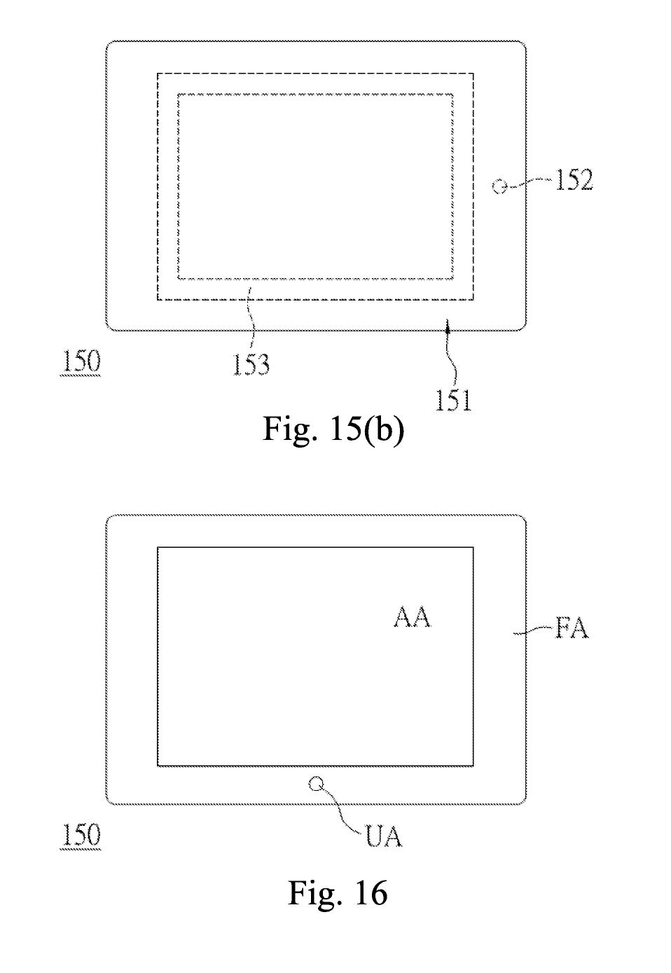

Please refer to FIGS. 15(a) to 15(b), which illustrate the eleventh embodiment in accordance with the present invention. The main difference between the eleventh embodiment, the previously disclosed fifth embodiment and the sixth embodiment is that there is a hollow space superimposed on the ITO conductive film. The superficial measurement of the hollow space is at least 1 mm×1 mm with no restriction in geometric shapes. The hollow space is disposed on the dielectric film layer 151 which is disposed on the frame area FA.

In FIG. 15(a), an ITO substrate 150 is first provided and the ITO conductive film layer 150a formed thereon is managed for an active area AA and a frame area FA in advance. For example, the surface impedance of the ITO conductive film is in a range of 150-300 ohm per square, but not limited thereto. In FIG. 15(b), a dielectric film layer 151 is formed on the frame area FA near edges of the ITO substrate 150 with a hollow space 152, especially on the inside frame of the frame area FA adjacent to the active area AA, the hollow space 152 are exposed by a process including one of the screen printing process, the transfer printing process, the inkjet printing process, and the plating process. It is to be noticed that the pattern of the dielectric film layer 151 can be planned to cover all the frame area FA and expose the hollow space 152 but not exposing the conductive area 153 inside the frame area FA when view from the top. The hollow space 152 can be also disposed in another location. The final appearance of the front of the ITO substrate 150 is orderly divided into an active area AA and a frame area FA with a hollow space as shown in FIG. 16, for example.

In some examples of the hollow space, the hollow space is in one shape selected from a group consisting of a circular shape, a square shape, a triangular shape and a combination thereof.

Embodiments of a method for manufacturing a structure of a touch panel are also further provided in the following.

In one embodiment, the method includes at least providing a first structure as an upper structure of the touch panel. Providing a first structure as an upper structure of the touch panel includes: providing a first substrate; forming a first transparent conductive layer disposed on the first substrate, wherein the first transparent conductive layer comprises at least one electrode; and forming an opaque area disposed on a peripheral area of the first transparent conductive layer, wherein the opaque area includes a conductive film layer. In this embodiment, the opaque area may further comprise a dielectric layer. In addition, in an example, the dielectric layer and the conductive film layer can be made overlap. In another example, the dielectric layer of the opaque area comprises at least one hollow space above at least a corresponding one of the at least one electrode of the first transparent conductive layer. In one example, the conductive film layer comprises at least one connection pad, wherein one of the at least one connection pad is disposed over one of the at least one hollow space and electrically coupled to the corresponding one of the at least one electrode of the first transparent conductive layer.

In another embodiment to provide a touch panel, such as a projective capacitive touch panel, the above method further includes: providing a second structure as a lower structure of the touch panel; forming an insulation layer between the first structure and the second structure; and combining the first structure with the second structure so as to provide the touch panel having an active area and a frame area.

In still another embodiment to provide a touch panel, such as a resistive touch panel, the above method further includes: providing a second structure as a lower structure of the touch panel; forming, on the second structure, an insulation layer having at least one via; forming a first conductive bump disposed within one of the at least one via and electrically coupled to at least one electrode of the second structure; forming a second conductive bump disposed within the one of the at least one via and electrically coupled to the first conductive bump; and combining the first structure with the second structure so as to provide the touch panel having an active area and a frame area, wherein the second conductive bump is electrically coupled to one of the at least one electrode of the first structure. In this embodiment, the second conductive bump can be smaller than the first conductive bump in size. In addition, the second conductive bump can be formed on the first conductive bump which is solidified.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A layer structure for a touch panel, comprising:
a substrate;
a transparent conductive layer, disposed on the substrate, comprising at least one electrode; and
an opaque area, disposed on a peripheral area of the transparent conductive layer, comprising a conductive film layer.

2. The layer structure of claim 1, wherein the opaque area further comprises a dielectric film layer.

3. The layer structure of claim 2, wherein the dielectric film layer and the conductive film layer overlap.

4. The layer structure of claim 2, wherein the dielectric film layer has a first color, the conductive film layer has a second color.

5. The layer structure of claim 4, wherein the first color is different from the second color.

6. The layer structure of claim 2, wherein the dielectric film layer of the opaque area comprises at least one hollow space above at least a corresponding one of the at least one electrode.

7. The layer structure of claim 6, wherein the conductive film layer comprises at least one connection pad, wherein one of the at least one connection pad is disposed over one of the at least one hollow space and electrically coupled to the corresponding one of the at least one electrode.

8. The layer structure of claim 6, wherein the hollow space has a superficial measurement greater than 1 mm×1 mm.

9. The layer structure of claim 8, wherein the hollow space is in one shape selected from a group consisting of a circular shape, a square shape, a triangular shape and a combination thereof.

10. The layer structure of claim 6, wherein the conductive film layer is superimposed on the hollow space.

11. The layer structure of claim 1, wherein the transparent conductive layer has an impedance in a range from 150 ohm per square to 300 ohm per square.

12. A touch panel, comprising:
an upper structure for providing an active area and a frame area, comprising:
a first substrate;
a first transparent conductive layer, disposed on the first substrate, comprising at least one electrode; and
an opaque area, disposed on a peripheral area of the first transparent conductive layer, including a conductive film layer; and
a lower structure comprising:
a second substrate; and
a second transparent conductive layer disposed on the second substrate.

13. The touch panel of claim 12, wherein the opaque area further comprises a dielectric film layer.

14. The touch panel of claim 13, wherein the dielectric film layer and the conductive film layer overlap.

15. The touch panel of claim 12, further comprising: an insulation layer disposed between the upper structure and the lower structure.

16. The touch panel of claim 12, further comprising:
an insulation layer having at least one via and disposed between the upper structure and the lower structure;
a first conductive bump disposed within one of the at least one via and electrically coupled to at least one electrode of the second transparent conductive layer; and
a second conductive bump disposed within the one of the at least one via and electrically coupled to the first conductive bump and one of the at least one electrode of the first transparent conductive layer.

17. The touch panel of claim 16, wherein the second conductive bump is smaller than the first conductive bump in size.
